(19) United States
(12) Patent Application Publication
(10) Pub. No.: US 2010/0122092 A1
(43) Pub. Date: May 13, 2010

(54) COMMUNITY-BASED IMAGE CATALOG

(76) Inventor: Mike M. Yaghmai, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/267,201

(22) Filed: Nov. 7, 2008

(51) Int. Cl. H04L 9/00; G06F 3/048; G06F 17/30

(52) U.S. Cl. 713/176; 715/808; 707/E17.014

(57) ABSTRACT

A community-based image catalog is provided. An example system to provide a community-based image catalog comprises a communications module to receive a submitted digital image at a server system, a detector to determine that the submitted digital image is to be made available for use by community members, a community image generator to add an interactive watermark to the submitted digital image thereby generating a community image, and a database interface module to provide the community image to a repository of images. An interactive watermark may be designed to be indicative of the community image being available for use by community members and being indicative of an interactive nature of the interactive watermark.

### TECHNICAL FIELD

This application relates to the field of electronic Commerce (eCommerce) and, specifically to a computer-implemented community-based image catalog.

### BACKGROUND

Copyrighted images may be submitted by users to an on-line transaction processing platform.

Many e-commerce companies, including, but not limited to, those that provide on-line trading services, are often presented with copyright issues, e.g., when a seller submits a digital image of an item to be posted for sale. An e-commerce company may have in place a user agreement that gives the company a license to use user-submitted images for purposes other than displaying an image of an item offered for sale. While such license may permit the company to use user-submitted images, the license may not necessarily cover the use of user-submitted images by other community members, including sellers and buyers.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example community-based image catalog may be implemented;

FIG. 2 is block diagram of a system to provide a community-based image catalog, in accordance with one example embodiment;

FIG. 3 is block diagram of an architecture for generating a community image, in accordance with one example embodiment;

FIG. 4 is block diagram of an architecture for processing a search request directed at a community-based image catalog, in accordance with one example embodiment;

FIG. 5 is block diagram of an architecture for monitoring user activities with respect to community images, in accordance with one example embodiment;

FIG. 6 is a flow chart of a method to provide a community-based image catalog, in accordance with an example embodiment;

FIG. 7 is an example user interface illustrating a digital image accessible via a community-based image catalog, in accordance with an example embodiment; and

FIG. 8 is a diagrammatic representation of an example machine in the form of a computer system within which a set of instructions, for causing the machine to perform any one or more of the methodologies discussed herein, may be executed.

### DETAILED DESCRIPTION

A community-based image catalog that provides a searchable collection of digital images is described. In the following description, for purposes of explanation, numerous specific details are set forth in order to provide a thorough understanding of an embodiment of the present invention. It will be evident, however, to one skilled in the art that the present invention may be practiced without these specific details.

Method and system are provided to allow users to reap the benefit of making their copyrighted digital images available to a community of users by preparing or processing the submitted image to serve as a billboard advertisement or a banner advertisement for the submitter. For example, when an image is submitted to the community-based image catalog, the image may serve as a way for the submitter to drive traffic to a web page that provides a variety of information about submitter. Such web page may also have information about items that are offered by the submitter for sale. In one embodiment, where the community-based image catalog is provided in the context of an on-line trading platform, such as the platform provided by eBay®, seller members of the eBay® community, by giving other community members access to their digital images, may experience increased traffic to their “About Me” web page, thus providing them with an additional venue to expose their listings on eBay® to an increased audience. EBay® is a registered trademark of the eBay® Inc. of San Jose, Calif.

In one example embodiment, a pool into which community members may submit their images may be termed a community-based image catalog. Images that are submitted to be searchable and freely available to community may be processed to make them clearly identifiable as such, e.g., in order to distinguish them from images submitted by users as part of their listings but not intended for unrestricted use by other community members. Such identification may be expressed in a variety of manners, such as by adding a distinct border around the image or embedding an interactive watermark into the image. Copyrighted images submitted for use by community members may be termed community images. A community image, as part of its metadata, may include a “public use” tag to identify it as a community image.

When a user submits a digital image to be included in a community-based image catalog, the image is processed to include into the image a watermark that identifies the image as a community image and also serves as an indicator of interactive features embedded in the watermark. A watermark may thus be referred to as an interactive watermark or an interactivity indicator that links the image to the submitter. For example, an interactive watermark, while being presented in a non-intrusive manner, may be associated with a pop-up window that appears on a user's display screen when the user's pointing device (e.g., a mouse cursor) hovers over the watermark. A pop-up window associated with an watermark may include information about the image submitter, as well as the link to a web page that may have additional information that the submitter may wish to expose to other members of e-commerce community. When a pop-up window associated with a community image and its interactive watermark is displayed to a user, the user may click through to access the submitter's web page to find out further information about the submitter.

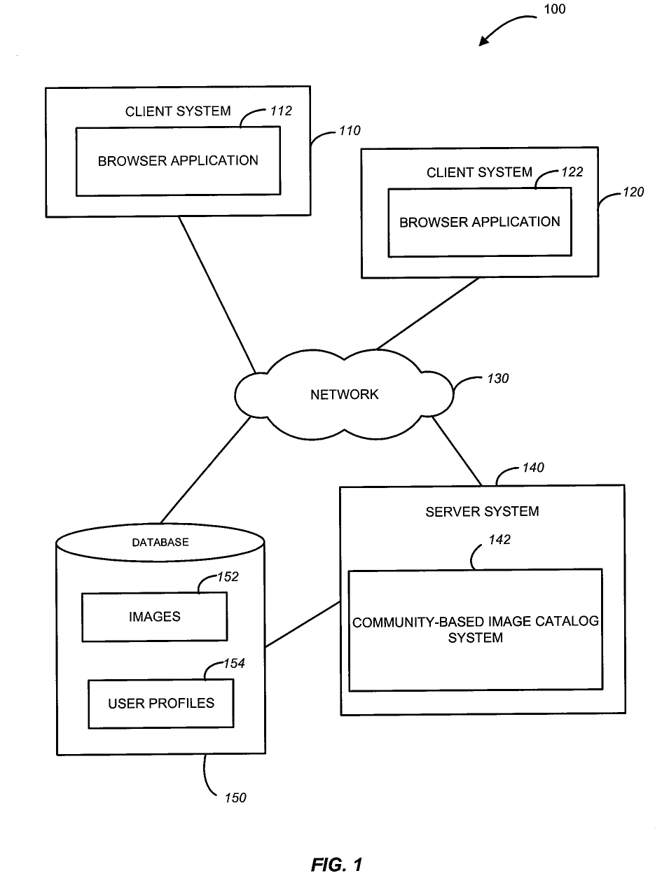

An example community-based image catalog may be accessed by community members for searching for specific images or for images associated with certain themes or key words. When an image from a community-based catalog is presented to a user, the user may be permitted to provide feedback regarding the image, e.g., in the form of a star rating. The submitter of the image may receive rewards based users' activity with respect to the submitted image, e.g., based on how many times the community image was accessed and used by other community members, based on the number and value of received ratings, as well as based on the total number of images contributed by the submitter to the community catalog. An example community-based image catalog may be implemented in the context of a network environment 100 illustrated in FIG. 1.

As shown in FIG. 1, the network environment 100 may include client systems 110 and 120 and a server system 140. The server system 140, in one example embodiment, may host an on-line trading platform. The client systems 110 and 120 may run respective browser applications 112 and 122 and may have access to the server system 140 via a communications network 130. The communications network 130 may be a public network (e.g., the Internet, a wireless network, etc.) or a private network (e.g., a local area network (LAN), a wide area network (WAN), Intranet, etc.).

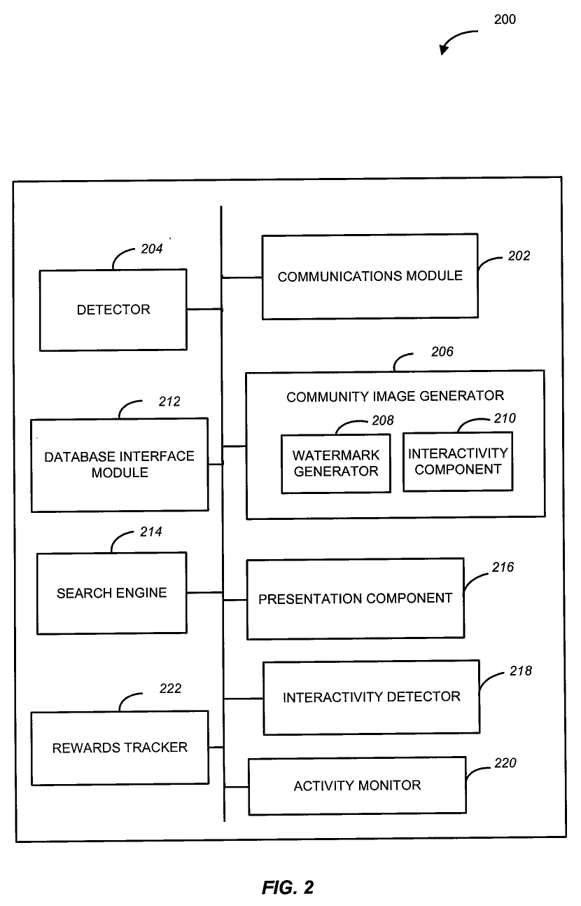

The client system 110 may utilize the browser application 112 to access services provided by the server system 140. For example, the server 140 may host a community-based image catalog system 142 associated with the on-line trading platform. The community-based image catalog system 142 may be configured to collect, process and provide access to digital images that were submitted for the purpose of being made available to community members. Community members, in this example, may be understood to include members of the on-line trading platform hosted by the server 140. As shown in FIG. 1, the community-based image catalog system 142 is connected to a database 150 that may store digital images 152 designated as community images, as well as profiles 154 of users who are members of on-line trading platform. An example community-based image catalog system is illustrated in FIG. 2.

FIG. 2 is a block diagram of a system 200 to provide a community-based image catalog, in accordance with one example embodiment. As shown in FIG. 2, the system 200 includes a communications module 202, a detector 204, a community image generator 206, and a database interface module 212. The communications module 202 may be configured to receive submitted digital images from users (e.g., from the client systems 110 and 120 of FIG. 1 controlled by users), as well as other information, such as feedback regarding community images and search requests directed at the database 150 of FIG. 1. The detector 204 may be configured to determine that a digital image received by the communications module 202 is submitted by a user for the purpose of it being made available to others (e.g., to other members of an associated on-line trading platform). The detector 204 may provide the results of this determination to the community image generator 206, which may be configured to process the submitted digital image into a community image.

As shown in FIG. 2, the community image generator 206 includes a watermark generator 208 and an interactivity component 210. The watermark generator 208 may be configured to embed a certain watermark into a submitted digital image if the submitted digital image is designated to be stored and made available as a community image. Such watermark may be indicative of the image that contains it being available for use by community members and also being indicative of an interactive nature of the watermark. Regarding the interactive nature of the watermark, the interactivity component 210 may be configured to associate the watermark (that may be referred to as an interactive watermark) with a pop-up window that is to be presented to a user whenever the user's cursor hovers over the watermark or over some other part of the community image. The pop-up window, in one example embodiment, may include information about the submitter of the community image (e.g., the submitter's name or community alias), as well as a link (e.g., in the form of a Uniform Resource Locator URL) on a vanity URL or button to the submitter's personalized web page. Thus, the community image generator 206, in one example embodiment, is configured to process a digital image into a community image by embedding into it an interactive watermark. The database interface module 212 may be configured to provide newly generated community imaged to a designated repository of community images (e.g., to the database 150 of FIG. 1), as well as to retrieve community images from such repository, e.g., in response to a search request from a community member.

The system 200 to provide a community-based image catalog may also include a search engine 214 and the presentation component 216. The search engine 214 may be configured to process search requests directed to a repository of community images and retrieve one or more community images that satisfy search criteria associated with the search request. The presentation component 216 may be configured to provide the retrieved images to the requesting client for rendering.

Other modules that may be provided with the system 200 may include an interactivity detector 218, an activity monitor 220, and a rewards tracker 222. The interactivity detector 218 may be configured to detect a pointer control (e.g., a mouse cursor) located over a portion of a community image and, in response, activate a pop-up window associated with the submitter of the community image. As mentioned above, the pop-up window may include a link to the submitter's web page, such that the viewer of the community image may clock through to access the submitter's personalized web page that may include further information about the submitter, as well as listings of items for sale offered by the submitter. The rewards tracker 222 may be configured to associate rewards with community members that submit digital images for community use. Rewards may be based on various activities monitored and collected by the activity monitor 220. Example activities that may be collected by the activity monitor 220 may include the total number of images submitted by a user for community use, data related to feedback provided by community members with respect to a particular community image, the frequency with which a particular community image is accessed by community members, etc.

There may be various ways to reward community members for submitting their copyrighted images for communal use. For example, a user may be awarded a certain designation (e.g., “A Top Contributor”) if the community images submitted by the user consistently receive high ratings from other members or are integrated into a certain number of third party listings. Such designation may be displayed prominently within a user's profile. Other ways to reward and encourage users to submit their copyrighted images for community use may include publicly recognizing top submitters on a regular basis (e.g., once a month), present submitters with gifts or vouchers based on a predetermined success criteria, or award monetary rewards. In one example embodiment, the rewards tracker 222 may associate rewards with community members based on the results of a contest, e.g., a contest for the best community image.

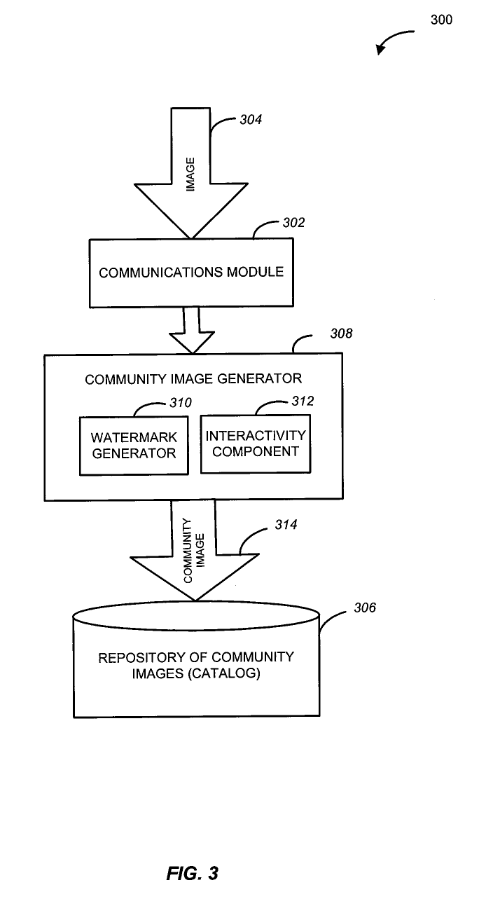

It will be noted, that while FIG. 2 shows particular modules as part of another component (e.g., the watermark generator 208 and the interactivity component 210 being part of the community image generator 206), other embodiments may be provided where some modules of the system 200 shown as separate components are implemented as a single module. Conversely, embodiments may be provided where a component that is shown in FIG. 2 as a single module may be implemented as two or more components. Example architectures illustrating various stages of operation of a system to provide a community-based image catalog are shown in FIGS. 3-5.

FIG. 3 is block diagram of an architecture 300 for generating a community image and storing it is a repository of community images, in accordance with one example embodiment. As shown in FIG. 3, a submitted digital image 304 is received at a communications module 302. A community image generator 308 engages a watermark generator 310 and an interactivity component 312 to process the submitted image 304 into a community image 314. The community image 314 is stored in a repository of community images 306. The repository of community images 306 may correspond to the images portion 152 of the database 150 of FIG. 1.

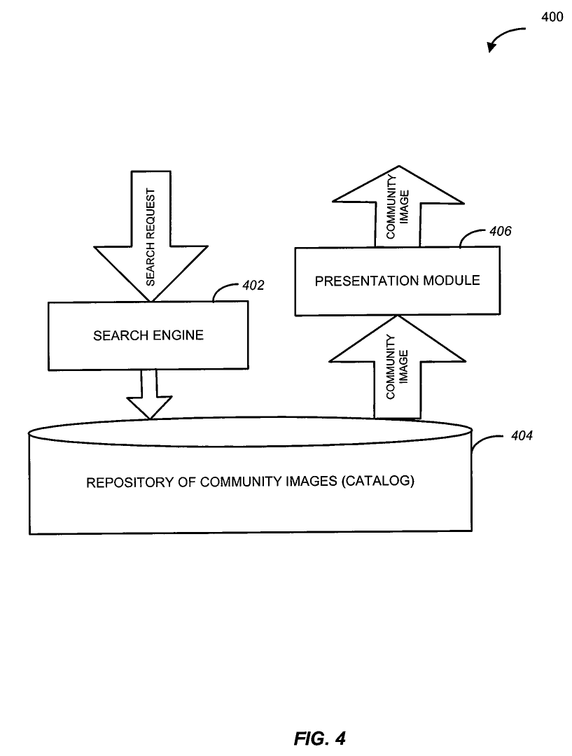

FIG. 4 is block diagram of an architecture 400 for processing a search request directed at a community-based image catalog 404, in accordance with one example embodiment. As shown in FIG. 4, a search engine 402 detects a search request and interrogates the repository of community images 404 with a search criteria associated with the search request. If there is a community image in the repository 404 that satisfies the search criteria, such community image is retrieved and provided to a client system associated with the requesting user via a presentation module 406. It will be noted, that while community images may be made available to community members by means of searching the repository of community images 404, a community image may also be presented in the context of displaying a listing via an on-line trading platform.

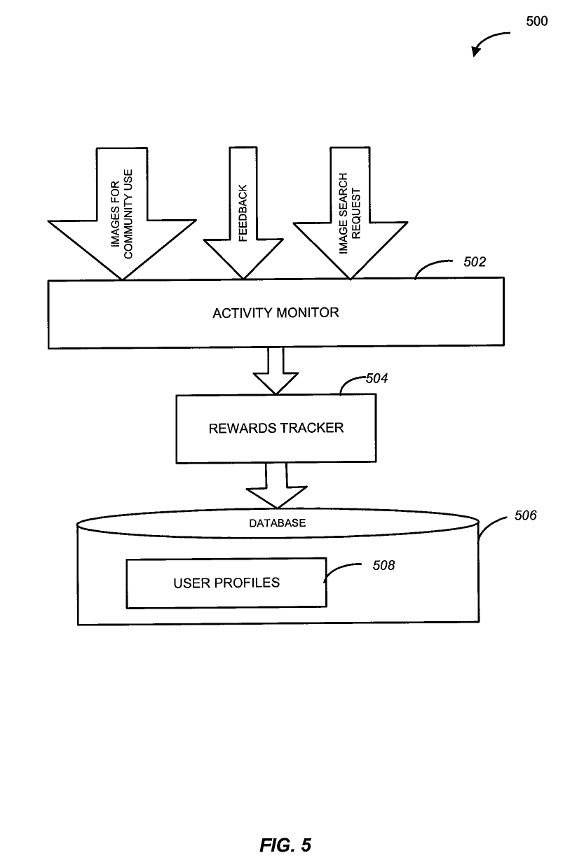

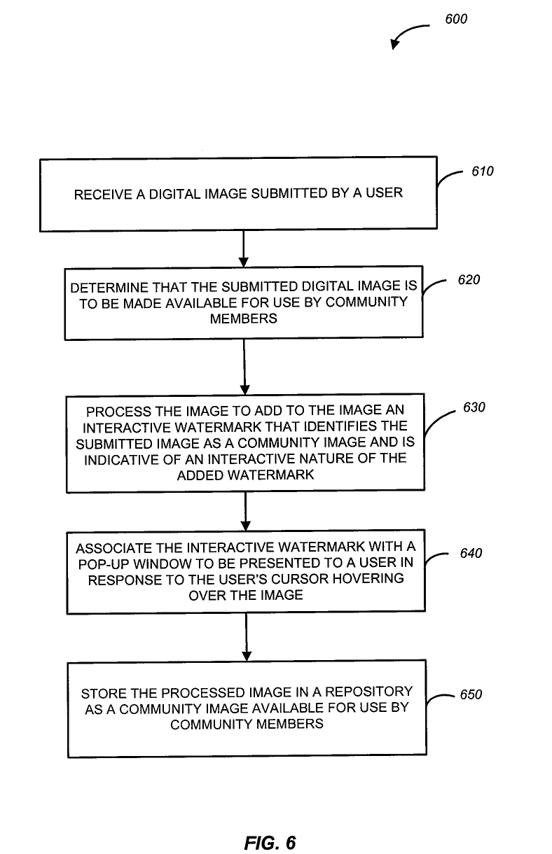

FIG. 5 is block diagram of an architecture 500 for monitoring user activities with respect to community images, in accordance with one example embodiment. As shown in FIG. 5, an activity monitor 502 detects activity such as a user submitting a digital image to a community-based image catalog, feedback or ratings with respect to community images, and image search requests and provides this information to a rewards tracker 504. The rewards tracker 504, keeps track of activities per submitter of community images and per community image and may associate a reward with a certain submitter based on this information. The reward information may be stored in a user profiles section 508 of a database 506. For example, a community user who submits a certain number of community images may be eligible for a reward. An example method to provide a community-based image catalog can be described with reference to FIG. 6.

FIG. 6 is a flow chart of a method 600 to provide a community-based image catalog, according to one example embodiment. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system to provide a community-based image catalog 200 shown in FIG. 2.

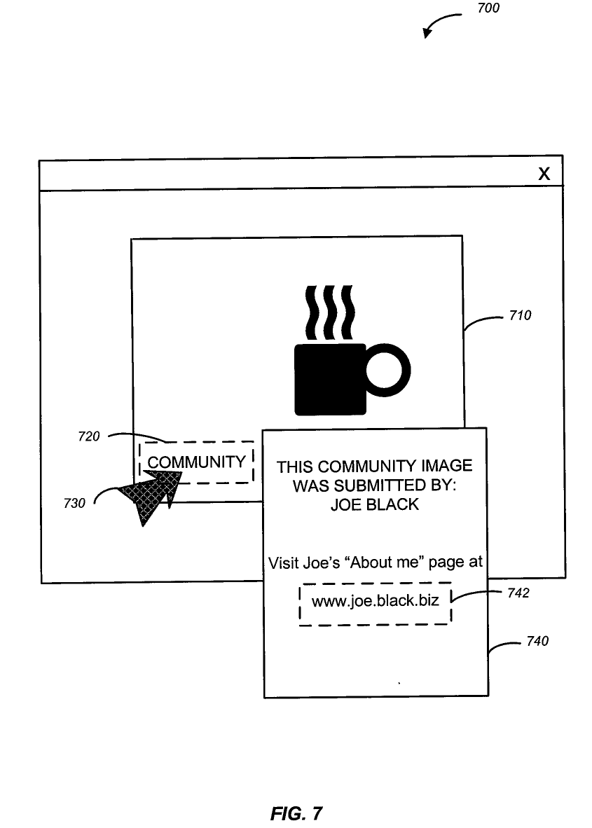

As shown in FIG. 6, the method 600 commences at operation 610, when the communications module 202 of FIG. 2 receives a digital image submitted by a user. At operation 620, the detector 204 of FIG. 2 determines that the submitted digital image is to be made available for use by community members, e.g., by adding the submitted image to a community-based image catalog. At operation 206, the community image generator 206 of FIG. 2 processes the image by engaging the watermark generator 208 to embed an interactive watermark into the image. The interactive watermark may be designed to identify the image as a community image and to be indicative of an interactive nature of the added watermark. The interactivity component 210 of FIG. 2, at operation 640, associates the interactive watermark embedded in the image with a pop-up window that may be presented on a user's display device when the user's cursor hovers over the interactive watermark or over any part of the image that includes the interactive watermark. Thus generated community image is stored in a repository of community images (e.g., in the database 150 of FIG. 1), at operation 650. An example digital image that may be accessed by users via a community-based image catalog is illustrated in FIG. 7.

As shown in FIG. 7, a user interface 700 is presenting a community image 710 that has an embedded interactive watermark 720. A user's cursor 730 is shown as hovering over the interactive watermark 720. Because the user's cursor 730 is shown as hovering over the interactive watermark 720, a pop-up window 740 is being displayed. The pop-up window 740 presents information about the submitter of the image 710, as well as a link 742 to the submitter's web page.

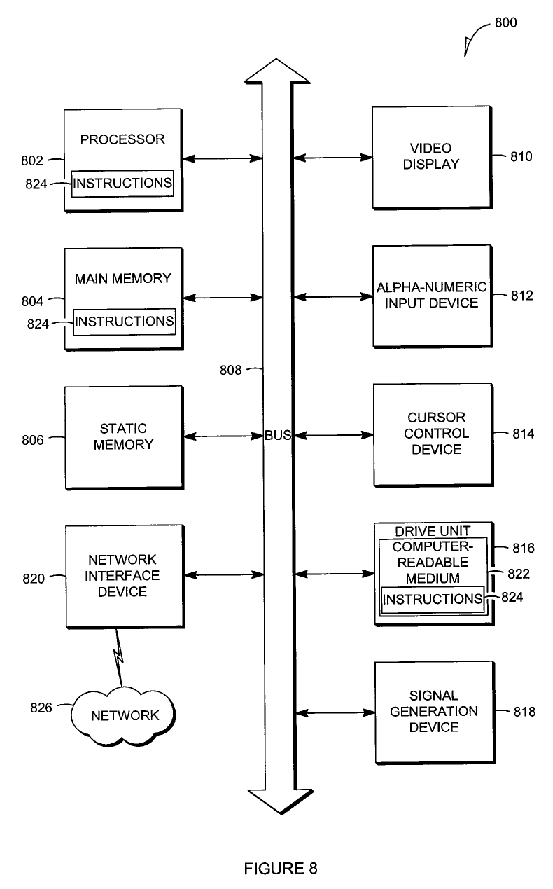

FIG. 8 shows a diagrammatic representation of a machine in the example form of a computer system 800 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g., a keyboard), a user interface (UI) navigation device 814 (e.g., a cursor control device), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a community-based image catalog has been described. The approaches described herein may encourage people to share their copyrighted material on a searchable bases with other community members in return for publicity. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

For example, while an embodiment has been described with reference to an on-line trading platform, a community-based image catalog may be implemented and utilized advantageously in the context of various other on-line platforms, as well as a stand-alone application for sharing copyrighted content.

What is claimed is:

1. A computer-implemented system comprising:
a communications module to receive a submitted digital image at a server system;
a detector to determine that the submitted digital image is to be made available for use by community members;
a community image generator to add an interactive watermark to the submitted digital image thereby generating a community image, the interactive watermark being indicative of the community image being available for use by community members and being indicative of an interactive nature of the interactive watermark; and
a database interface module to provide the community image to a repository of images.

2. The system of claim 1, including a watermark generator to embed the interactive watermark into the submitted digital image.

3. The system of claim 1, including an interactivity component to associate the interactive watermark with a pop-up window, the pop-up window to be presented to a user in response to an action by the user with respect to the community image.

4. The system of claim 3, wherein the pop-up window includes a link to a web page associated with a submitter of the digital image.

5. The system of claim 1, including a search engine to:
receive a search request directed at the repository of images, the repository of images storing images designated as being available for use by community members;
determine that the community image satisfies a search criteria associated with the search request; and
retrieve from the repository of digital images the community image.

6. The system of claim 5, wherein the communications module is to receive feedback data associated with the community image.

7. The system of claim 5, including an interactivity detector to:
detect a pointer control located over a portion of the community image, while the community image is being displayed on a display device; and
react to the detecting of the pointer control located over a portion of the community image by activating a pop-up window including information associated with a submitter of the digital image.

8. The system of claim 7, wherein the portion of the community image includes at least a portion of the interactive watermark.

9. The system of claim 1, including a rewards tracker to associate with a submitter of the community image a reward based on a number of digital images submitted by the submitter for a purpose of community use.

10. The system of claim 1, wherein the interactive watermark is indicative of the digital image being available for use by community members that are members of an on-line trading community.

11. A computer-implemented method comprising:
using one or more processors to perform operations of:
receiving a submitted image at a computer system;
determining that the submitted image is to be made available for use by community members;
processing the submitted image to add an interactive watermark thereby generating a community image, the interactive watermark being indicative of the community image being available for use by community members and being indicative of an interactive nature of the interactive watermark; and
storing the community image in a repository of images.

12. The method of claim 11, wherein the interactive watermark is indicative of the digital image being available for use by community members that are members of an on-line trading community.

13. The method of claim 11, including associating the interactive watermark with a pop-up window, the pop-up window to be presented to a user in response to an action by the user with respect to the community image.

14. The method of claim 13, wherein the pop-up window includes a link to a web page associated with a submitter of the digital image.

15. The method of claim 11, including:
receiving a search request directed at the repository of images, the repository of images storing images designated as being available for use by community members;
determining that the community image satisfies a search criteria associated with the search request; and
retrieving from the repository of digital images the community image.

16. The method of claim 15, including receiving feedback data associated with the community image.

17. The method of claim 15, including:
detecting a pointer control located over a portion of the community image, while the community image is being displayed on a display device; and
reacting to the detecting of the pointer control located over a portion of the community image by activating a pop-up window including information associated with a submitter of the digital image.

18. The method of claim 17, wherein the portion of the community image includes at least a portion of the interactive watermark.

19. The method of claim 11, including associating with a submitter of the community image a reward based on a predetermined criteria.

20. The method of claim 19, wherein the predetermined criteria is associated with a number of digital images submitted by the submitter for a purpose of community use.

21. A machine-readable medium having instruction data to cause a machine to:
receive a submitted image at a server system;
determine that the submitted image is to be made available for use by community members;
process the submitted image to add an interactive watermark thereby generating a community image, the interactive watermark being indicative of the community image being available for use by community members and being indicative of an interactive nature of the interactive watermark; and
store the community image in a repository of images.
